(19) United States
(12) Patent Application Publication
(10) Pub. No.: US 2017/0100876 A1
(43) Pub. Date: Apr. 13, 2017

(54) METHOD FOR MANUFACTURING A SHOWER TRAY TROUGH FROM A COMPOSITE PANEL

(71) Applicants: Farhooman Davoudi, Roissy en Brie (FR); ASM, Guerande (FR)

(72) Inventor: Farhooman Davoudi, Roissy en Brie (FR)

(21) Appl. No.: 15/290,937

(22) Filed: Oct. 11, 2016

(30) Foreign Application Priority Data
Oct. 12, 2015 (FR) 1559672

(51) Int. Cl. B29C 59/02; B29C 35/02; B29C 69/00; B32B 38/06; B32B 37/12; B32B 37/06; B29C 65/02; B32B 38/00; B29C 65/48; B29C 35/16

(52) U.S. Cl. CPC B29C 59/022; B29C 65/48; B29C 59/026; B29C 35/02; B29C 69/001; B29C 35/16; B32B 37/12; B32B 37/06; B29C 65/02; B32B 38/0004; B32B 38/06; B29K 2025/06

(57) ABSTRACT

The present invention relates to a method for manufacturing a shower tray trough, from a composite panel of the sandwich type, to which a mask is applied corresponding to a pattern cavity making it possible to imprint, in the thickness of the foam reinforcing slab of said composite panel, the desired recesses to form said shower tray trough. To that end, the top plate of the composite panel is heated locally, only at the zones corresponding to the recesses to be imprinted, so as to allow the deformation of said top plate and the arrangement of said recesses in the thickness of the foam slab.

### FIELD OF ART

The invention relates to an original and cost-effective method for manufacturing a shower tray trough from a composite panel of the sandwich type.

More specifically, the present invention relates to the manufacture of a shower tray trough quickly and efficiently in terms of energy and time using a technique in particular comprising local heating of the top plate of a composite panel and pressing, against said top plate heated locally, a mold forming a mask corresponding to the pattern cavity of the recesses to be imprinted in said composite panel that forms said shower tray trough.

### BACKGROUND

The general issue relates to the manufacture of shower tub troughs from plastic.

To that end, it is known to use thermoforming techniques to obtain a plate marked with the pattern cavity corresponding to the desired recesses, the thermoformed plate next being reinforced, dried and cut to form a shower tray trough having the desired shape and dimensions.

In practice, the thermoforming technique consists, as known by those skilled in the art, of heating the entirety of a large plate, typically made from plastic, to soften it, so as to shape it into the desired shape using a mold, said plate having been made ductile via the heating over its entire surface.

After a long drying and cooling time, the large thermoformed plate is reinforced, for example using glass fiber or polyurethane foam, to give it a satisfactory mechanical strength.

It should be noted that this reinforcing step is essential, since without this, the plastic plate shaped by thermoforming cannot have an acceptable mechanical strength, in particular for a shower tray trough.

Thus, after drying and cooling of the plastic plate shaped by thermoforming and reinforced, the obtained part is cut to produce clean edges and produce a shower tray trough having the desired dimensions.

This known technique therefore causes very high energy consumption, due to the use of a thermoforming method, and significant related pollution, due to the scraps resulting from the cuts necessary to form a shower tray trough with the desired dimensions.

There is therefore a need for a method for manufacturing shower tray troughs that create less pollution and save more energy.

To that end, the present invention proposes a method for manufacturing shower tray troughs comprising producing a mold forming a mask corresponding to the pattern cavity of the desired recesses, said mask being imprinted into the thickness of the foam of a composite panel of the sandwich type, through the pushing in of an upper plate of said composite panel, heated beforehand in a localized manner, in order to slightly soften only the zones of said upper plate corresponding to the recesses provided to be imprinted in the depth using a pattern cavity.

The mask is thus imprinted into the depth of the foam of the composite panel using a thermal compression technique.

The method according to the invention thus avoids, on the one hand, having to heat an entire plastic plate, and therefore also makes it possible to save on the associated drying and cooling time, and on the other hand, the related pollution caused by the pushing in and cutting of thermoformed panels, due to the use of composite panels of the sandwich type, previously reinforced.

### SUMMARY

To that end, more specifically, the invention relates to a method for manufacturing a shower tray trough comprising the following steps:
producing a composite panel of the sandwich type, comprising a planar plastic top plate, situated opposite a planar plastic bottom plate, the bottom plate being intended to be found on a floor side once the shower tray trough is completed and installed, the top plate being separated from the bottom plate by a foam slab, for example expanded polystyrene, having a thickness,
producing a mold forming a pattern cavity of recesses to be imprinted in the depth of the composite panel,
localized heating of the top plate of the composite panel, to heat and soften only the zones corresponding to the pattern cavity of the recesses to be imprinted in the composite panel,
applying the pattern cavity on the top plate heated locally, so as to imprint the pattern cavity of the corresponding recesses, said pattern cavity of the recesses being arranged in the thickness of the foam slab, the bottom plate remaining planar, the zones corresponding to the pattern cavity of the recesses being heated so as to soften said zones of the top plate, such that the application of the pattern cavity causes a deformation and pushing in of the top plate matching the pattern cavity of the recesses, and the foam slab having a density suitable for allowing the impression of the pattern cavity of the recesses in the thickness of said foam slab,
cooling the composite panel having the pattern cavity of the desired recesses, to form a shower tray trough.

One essential advantage of the method according to the invention relative to the known thermoforming method consists of the very significant decrease in energy consumption caused by the manufacture of shower tray troughs. The energy consumed by the manufacture of a shower tray trough may thus be divided by 100 relative to the implementation of a traditional thermoforming technique. Added to the economic and ecological advantage that this creates is a gain in terms of time, since a much shorter heating time is required, and practically no drying time. One advantage also lies in the possibility of implementing the manufacturing method according to the invention on a short and compact production line, freed from bulky heating means and other drying apparatuses that are essential to carry out traditional thermoforming techniques.

Another advantage of the method according to the invention lies in the use of composite panels of the sandwich type, reinforced by a foam slab, have a good mechanical strength, constant even in case of cutting.

Furthermore, during the implementation of the method according to the invention, the part of the top plate not heated retains a smooth and clean appearance, whereas in the state of the art, even the parts intended to remain planar are heated, then cooled, at the risk of giving them a warped appearance.

In particular, the bottom plate remains completely planar, since the pattern cavity is configured such that the desired recesses are arranged in the thickness of the foam slab.

Another advantage of the manufacturing method according to the invention lies in the possibility of producing custom shower tray troughs, without shape limitation caused by said manufacturing method.

According to one preferred embodiment, before the heating step, the method according to the invention comprises a step for placing a heat screen to protect the part of the top plate not corresponding to zones corresponding to the pattern cavity of the recesses to be imprinted, said part of the top plate thus being preserved from any softening.

According to one embodiment, the method further comprises an initial step and/or a final step for cutting the composite panel to the desired dimensions of the shower tray trough.

According to one embodiment, the step for applying the mask on the top plate of the composite panel heated locally consists of pressing the mold against said top plate, after the heating step or simultaneously with the heating step, with a pressure comprised between about 4 and about 5 kilograms per square centimeter.

According to one submitted embodiment, the production of the composite panel includes a step for preforming the foam slab, prior to a step for gluing the top plate and the bottom plate on either side of said foam slab, so as to imprint, in the thickness of said foam slab, a primary pattern cavity corresponding to the recesses of the mask.

According to one particular embodiment, the method according to the invention further comprises a step for placing at least one weldable profile to hide the foam slabs and create a sealing border for the trough, and a plastic welding step for said at least one weldable profile on the shower tray trough.

Advantageously, the top plate and the bottom plate can be made from different materials, the bottom plate for example being able to be made from acrylic, and the top plate for example from aluminum, acrylic, ABS (acrylonitrile butadiene styrene), or PVC (polyvinyl chloride), said bottom plate and said top plate being separated by the foam slab having a thickness.

According to one embodiment, the foam slab is made from polystyrene.

According to another embodiment, the foam slab is made from polyurethane or, depending on the specific case, thin thermoformable resin.

According to another embodiment, the foam slab is made up of a polymer or a resin suitable for facilitating setting of the pattern cavity.

### BRIEF DESCRIPTION OF THE DRAWINGS

The invention will be better understood upon reading the following description, provided solely as an example, and done in reference to the appended drawings, in which:

FIG. 1 shows an example shower tray trough manufactured using the method according to the invention;

FIG. 2 shows an exploded view of a complete shower tray trough, manufactured using the method according to the invention.

### DETAILED DESCRIPTION

The invention is presented primarily for an application to the manufacture of shower tray troughs, but its application to the manufacture of other sanitary troughs, such as sinks or bathtubs, is also covered by the present invention.

First, as previously mentioned, the method for manufacturing shower tray troughs according to the invention provides the use of composite panels of the sandwich type, preferably with a structure that has previously been reinforced.

Such composite panels of the sandwich type comprise two plates, i.e., a top plate and a bottom plate, which can be made from different materials, separated by a foam slab having a thickness. For example, the bottom plate can be made from acrylic and the top plate from aluminum, acrylic, ABS or PVC, for example. The foam slab can for example be made from expanded polystyrene.

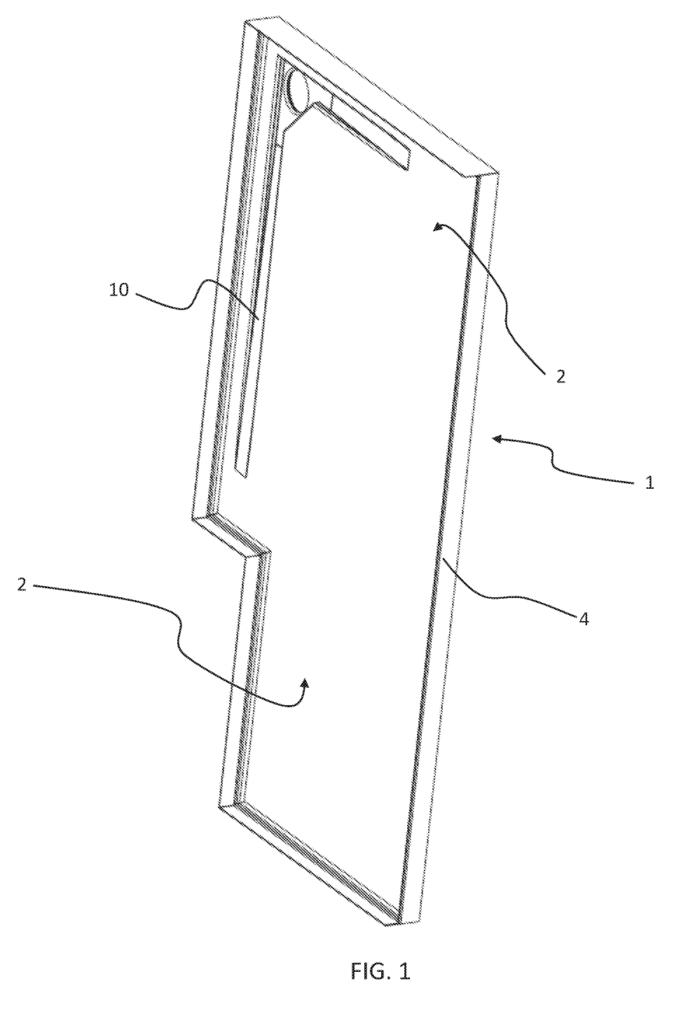

In reference to FIG. 1, the method for manufacturing shower tray troughs according to the invention therefore provides for the production of composite panels 1 having suitable dimensions.

Such a composite panel of the sandwich type has a planar bottom plate 2, intended to remain planar at the end of the manufacturing process, and located on the floor side once the shower tray trough is installed.

Opposite the bottom plate 2, the composite panel 1 has a top plate 3. The bottom 2 and top 3 plates are made from plastic resin, for example acrylic or ABS. Both are glued, respectively, on either side of a reinforcing foam slab 4, for example made from polyurethane or expanded polystyrene, or PVC (polyvinyl chloride) foam or any other similar material, having mechanical characteristics, in terms of strength and density in particular, suitable for the considered application, i.e., reinforcing composite panels intended to form [shower] tray troughs, with all that that implies in terms of the necessary mechanical strength.

Henceforth, one important advantage should be noted that the use of composite panels of the sandwich type, reinforced with foam, presents relative to the known thermoforming techniques for resin plates, in order to form upper shower tray trough plates. Indeed, the shower tray troughs manufactured using the traditional thermoforming methods are generally made up of acrylic reinforced with glass fiber. These trays are made fragile by the cuts necessary after thermoforming and reinforcement, in order to produce shower tray troughs with the desired dimensions. They indeed lose part of their mechanical strength during these cuts. On the contrary, composite panels of the sandwich type, implemented in the present invention, can be cut freely with no negative impact on their mechanical strength.

From such a composite panel of the sandwich type, the present invention provides, as previously indicated, the following successive steps:
producing a mold forming a mask corresponding to the pattern cavity of recesses 10 to be imprinted in the composite panel to form the shower tray troughs,
localized heating of the top plate 3 of the composite panel 1, to heat and soften only the zones of said top plate 3 corresponding to the pattern cavity of the recesses 10 to be imprinted in the composite panel 1,
applying the mask on the top plate heated locally, so as to imprint the pattern cavity of the corresponding recesses 10, said pattern cavity of the recesses being arranged in the thickness of the foam slab 4, the bottom plate 2 remaining planar, the zones of the top plate 3 corresponding to the pattern cavity of the recesses being heated so as to soften said zones of the top plate 3, such that the application of the mask, typically by pressing, causes a deformation and pushing in of the top plate 3 matching the pattern cavity of the recesses 10, and the foam slab 4 having a suitable density to allow the impression of the pattern cavity of the recesses 10 in the thickness of said foam slab 4,
given that the drying step does not exist, the cooling of the composite panel 1 having the pattern cavity of the desired recesses 10 to form the shower tray trough is therefore faster and more cost-effective.

Preferably, before the heating step, a heat screen is placed to protect the part of the top plate 3 not corresponding to the zones to be heated to allow imprinting in the depth of the pattern cavity of the recesses 10, said part of the top plate thus being preserved from any heating and softening. The advantage obtained lies in the fact that the part that is not heated, since it is protected by the heat screen, and therefore not softened, does not undergo any deformation of its surface during cooling. The appearance of the part that is not heated therefore remains vertically smooth and clean at the end of the manufacturing method.

In practice, according to the preferred embodiment, the mold is heated to a temperature close to that of the heated zones of the top plate, and pressed against the top plate 3. The heating of the top plate 3, and if applicable heating of the mold, and the pressing of the mold against the top plate 3 can be simultaneous. Alternatively, the heating occurs before the pressing of the mold against the top plate 3.

Thus, preferably, the pattern cavity of the recesses 10 is imprinted in the composite panel 1, in the thickness of the foam slab 4, owing to the thermocompression technique described above.

It should also be noted that the use of this thermocompression technique has the advantage, in particular when the mold is simultaneously or in any case quickly pressed against the top plate, that the localized heating of the top plate 3 can be done at a temperature lower than that required by the known thermoforming technique, which requires complete softening of the plate to be formed. Heating less has the advantage, aside from the economic and ecological interest, of greatly decreasing the risk of experiencing a deformation of the surface during cooling of the plate.

Thus, contrary to the known thermoforming technique, it is not necessary, in the method according to the invention, to heat and soften the entire surface of the top plate 3. Only the zones corresponding to the recesses 10 to be imprinted are heated and softened to allow the application, typically done by pressing, of the mold on the top plate 3 of the composite panel to result in imprinting the pattern cavity corresponding to the desired recesses 10 in the thickness of the foam slab 4 of said composite panel 1.

Furthermore, the use of a composite panel of the sandwich type, reinforced from the start by foam, makes it possible to obtain a shower tray trough quickly after a short cooling step. On the contrary, the plates thermoformed according to the state of the art must be subject to long and costly drying steps in enormous drying cabinets, then cooling, as well as reinforcement with foam, polystyrene or polyurethane for example, or glass fiber, lastly before the performance of the cuts to the desired dimensions for the shower tray trough.

These cuts, as previously stated, also make the shower tray troughs thus manufactured more fragile.

On the contrary, the method according to the invention allows the use of composite panels prepared at the desired shower tray trough dimensions. If applicable, these cuts of the shower tray trough, manufactured according to the present invention, can be made for finishing or by the installer to adapt it to its placement location, without making the shower tray trough fragile due to the use of reinforced composite panels.

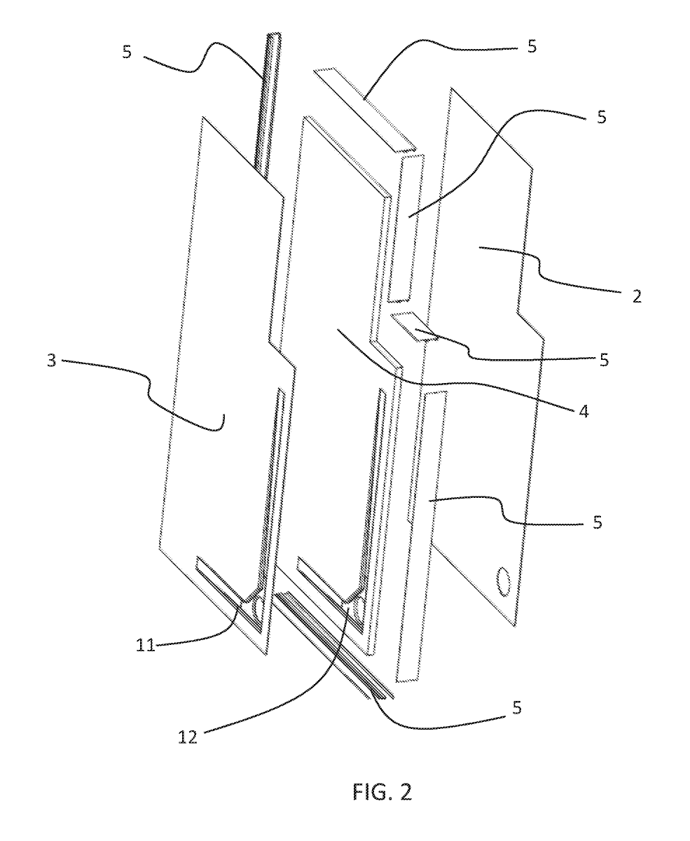

FIG. 2 shows an exploded view of a shower tray trough, manufactured using the method according to the invention. The composite panel formed from the bottom plate 2, the top plate 3 and the foam slab 4 has received the application of the mold forming the mask corresponding to the desired recesses (deformation of the top plate 2) and 12 (pushing of the recesses into the thickness of the foam slab 4), imprinted in the thickness of the foam slab 4 after deformation of the top plate 3.

As shown in the embodiment illustrated in FIG. 2, finishing is done using profiles 5 placed so as to conceal the foam slab 4. Preferably, these profiles 5 are weldable profiles made permanently secured to the composite panel 1—having become the shower tray trough—by plastic welding. Alternatively, the profiles 5 could be profiles for example made from plastic, glued so as to conceal the foam slab 4.

Furthermore, according to one submitted embodiment of the method according to the invention, it is provided, during the manufacture of the composite panels of the sandwich type, to preform the foam slab 4, preferably from polystyrene or alternatively from polyurethane, or made up of any other appropriate polymer resin, to facilitate the setting of the pattern cavity. Thus, matching the recesses 11, 12 provided to be imprinted during the application of the mask against the top plate 3 of the composite panel, the foam slab 4 is preformed, for example hollowed, so as to favor the pushing in corresponding to said recesses 12, caused by the application of the mask. In this way, the pattern cavity of the recesses 11, 12 desired for the shower tray trough can be more effectively imprinted in the thickness of the foam slab 4.

In summary, the present invention relates to a method for manufacturing a shower tray trough, from a composite panel 1 of the sandwich type, to which a mask is applied corresponding to a pattern cavity making it possible to imprint, in the thickness of the foam slab 4 reinforcing said composite panel, the desired recesses 10 to form said shower tray trough. To that end, the top plate 3 of the composite panel 1 is heated locally, only at the zones corresponding to the recesses 10 to be imprinted, so as to allow the deformation of said top plate 3 and the arrangement of said recesses in the thickness of the foam slab 4.

It should further be noted that the invention is not limited to the embodiments described as an example and is open to alternatives within the reach of one skilled in the art.

1. A method for manufacturing a shower tray trough comprising the following steps:
producing a composite panel of a sandwich type comprising a planar plastic top plate situated opposite a planar plastic bottom plate, the bottom plate being intended to be found on a floor side once the shower tray trough is completed and installed, the top plate being separated from the bottom plate by a foam slab having a thickness,
producing a mold forming a pattern cavity of recesses to be imprinted in the depth of the composite panel,
localized heating of the top plate of the composite panel, to heat and soften only the zones corresponding to the pattern cavity of the recesses to be imprinted in the composite panel,
applying the pattern cavity on the top plate heated locally, so as to imprint the pattern cavity of the corresponding recesses, said pattern cavity of the recesses being arranged in the thickness of the foam slab, the bottom plate remaining planar, the zones corresponding to the pattern cavity of the recesses being heated so as to soften said zones of the top plate, such that the application of the pattern cavity causes a deformation and pushing in of the top plate matching the pattern cavity of the recesses, and the foam slab has a density suitable for allowing the impression of the pattern cavity of the recesses in the thickness of said foam slab,
cooling the composite panel having the pattern cavity of the desired recesses, to form a shower tray trough.

2. The method for manufacturing a shower tray trough according to claim 1, comprising, before the heating step, a step for placing a heat screen to protect the part of the top plate not corresponding to zones corresponding to the pattern cavity of the recesses to be imprinted, said part of the top plate thus being preserved from any softening.

3. The method for manufacturing a shower tray trough according to claim 1, further comprising an initial step, a final step, or both an initial step and a final step for cutting the composite panel to the desired dimensions of the shower tray trough.

4. The method for manufacturing a shower tray trough according to claim 1, wherein the step for applying the mask on the top plate of the composite panel heated locally consists of pressing the mold against said top plate, after the heating step or simultaneously with the heating step, with a pressure comprised between about 4 and about 5 kilograms per square centimeter.

5. The method for manufacturing a shower tray trough according to claim 1, wherein the production of the composite panel includes a step for preforming the foam slab, prior to a step for gluing the top plate and the bottom plate on either side of said foam slab, so as to imprint, in the thickness of said foam slab, a primary pattern cavity corresponding to the recesses of the mask.

6. The method for manufacturing a shower tray trough according to claim 1, further comprising a step for placing at least one weldable profile to hide the foam slab and create a sealing border for the trough, and a plastic welding step for said at least one weldable profile on the shower tray trough.

7. The method for manufacturing a shower tray trough according to claim 1, wherein the bottom plate is made from acrylic, and the top plate is made from aluminum or acrylic or ABS or PVC, said bottom plate and said top plate being separated by the foam slab having a thickness.

8. The method for manufacturing a shower tray trough according to claim 1, wherein the foam slab is made from polystyrene.

9. The method for manufacturing a shower tray trough according to claim 1, wherein the foam slab is made from polyurethane.

10. The method for manufacturing a shower tray trough according to claim 1, wherein the foam slab is made up of a polymer or a resin suitable for facilitating setting of the pattern cavity.
